(19) United States
(12) Patent Application Publication
(10) Pub. No.: US 2025/0388803 A1
(43) Pub. Date: Dec. 25, 2025

(54) DRY FRICTION REDUCERS AND METHODS OF MAKING AND USING THE SAME

(71) Applicant: ADVANCED FRAC TECHNOLOGIES LLC, East Weston, WV (US)

(72) Inventor: Brad Davisson, Weston, WV (US)

(21) Appl. No.: 19/075,349

(22) Filed: Mar. 10, 2025

Related U.S. Application Data
(60) Provisional application No. 63/563,541, filed on Mar. 11, 2024.

(51) Int. Cl. C09K 8/70

(52) U.S. Cl. CPC C09K 8/70; C09K 2208/28

(57) ABSTRACT

A composition for hydraulic fracturing comprising a dry friction reducing polymer and methods of making and using the same are disclosed.

### CROSS-REFERENCE TO RELATED APPLICATIONS

This application claims the benefit of U.S. Provisional Patent Application No. 63/563,541, filed on Mar. 11, 2024, which is incorporated herein by reference in its entirety.

### FIELD

Embodiments disclosed herein are directed to hydraulic fracturing technologies, and more particularly to dry friction reducers for hydraulic fracturing.

### BACKGROUND

The oil and gas industry utilizes a dry friction reducer for hydraulic fracturing. However, such dry friction reducers only make up about 10% of the industry's friction reducer needs, despite being safer, better for the environment, and more cost-effective than the other types of friction reducers. The main reason dry friction reducers are not utilized to their full potential is the ease of use of these materials. A dry friction reducer needs expensive dissolution equipment and abundant clean water to dilute the dry friction reducer before application, has significant issues with cleanliness and utilization of space on a hydraulic fracturing spread, and uses a significant amount of space at the hydraulic fracturing site.

### SUMMARY

Therefore, a need remains for development of dry friction reducers that do not require special equipment at the hydraulic fracturing site and are more ecologically sustainable. The present disclosure addresses these needs.

The present disclosure provides a composition for hydraulic fracturing, the composition comprises: a dry friction reducing polymer comprising polyacrylamide; and a surfactant, wherein the composition comprises a plurality of particles having an average particle size of from 15 μm to 45 μm.

In an embodiment, either alone or in combination with any other embodiment, a method for producing a dry friction reducing composition for hydraulic fracturing comprises: mixing a dry friction reducing polymer comprising polyacrylamide with a surfactant to produce a course composition; and processing the course composition to form the dry friction reducing composition, the dry friction reducing composition comprising a plurality of particles having an average particle size of from 15 μm to 45 μm.

In an embodiment, either alone or in combination with any other embodiment, a geologic formation comprises a composition for hydraulic fracturing, the composition comprising: a dry friction reducing polymer comprising polyacrylamide; and a surfactant, wherein the composition comprises a plurality of particles having an average particle size of from 15 μm to 45 μm.

In an embodiment, either alone or in combination with any other embodiment, a method for extracting crude oil and natural gas from a geologic formation, the method comprises: supplying a composition for hydraulic fracturing to the geologic formation comprising: a dry friction reducing polymer comprising polyacrylamide; and a surfactant, wherein the composition comprises a plurality of particles having an average particle size of from 15 μm to 45 μm.

In an embodiment, either alone or in combination with any other embodiment, the surfactant is selected from the group consisting of dodecyl benzene sulphonic acid, cocamidopropyl betaine, sodium cocoiminodipropionate, dodecyl benzene sulphonic acid, dodecylbenzene dulphonate sodium salt, sodium lauryl sulphate, alkyl ether sulfate sodium salt, cetyl oleyl ethoxy phosphate, phenol+4EO phosphate ester−acid form, C8-10 alkyl polyglucosides, C10 alcohol+8EO, C13 alcohol+7EO, C16-18 alcohol+35EO, ethoxylated propoxylated C8-18 alcohols, oleic acid+10EO, PEG400 mono-oleate, sorbitan monostearate, sorbitan trioleate, tallow amine+15EO, lauryl amine oxide, and a combination of two or more thereof.

In an embodiment, either alone or in combination with any other embodiment, the composition further comprises a wetting agent selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated)methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

In an embodiment, either alone or in combination with any other embodiment, the plurality of particles have an average particle size from 25 μm to 35 μm.

In an embodiment, either alone or in combination with any other embodiment, the plurality of particles have an average particle size of about 30 μm.

In an embodiment, either alone or in combination with any other embodiment, the supplying the composition for hydraulic fracturing to the geologic formation comprises: adding the composition to a mobile delivery apparatus at a first site that is not the geologic formation; and delivering the mobile delivery apparatus to a second site housing the geologic formation.

In an embodiment, either alone or in combination with any other embodiment, the supplying the composition for hydraulic fracturing to the geologic formation comprises: dosing the composition from the mobile delivery apparatus into a secondary container comprising hydraulic fracturing fluid precursor to produce a hydraulic fracturing fluid; and supplying the hydraulic fracturing fluid to the geologic formation.

In an embodiment, either alone or in combination with any other embodiment, the supplying the composition for hydraulic fracturing to the geologic formation comprises: dosing the composition directly into the geologic formation.

These and other embodiments, forms, features, and aspects of the disclosure will become more apparent through reference to the following description, the accompanying figures, and the claims. This summary is not intended to identify key or essential features of the claimed subject matter, nor is it intended to be used as an aid in limiting the scope of the claimed subject matter. Additionally, it is to be understood that the features of the various embodiments described herein are not mutually exclusive and can exist in various combinations and permutations. Furthermore, it is envisioned that alternative embodiments may combine features of two or more of the above-summarized embodiments. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 shows a schematic of an exemplary system for delivering the composition for hydraulic fracturing to a geologic formation, in accordance with embodiments described herein.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

Unless defined otherwise, all technical and scientific terms used herein have the same meaning as is commonly understood by one of ordinary skill in the art to which this disclosure belongs. All patents, applications, published applications and other publications referred to herein are incorporated by reference in their entireties. If a definition set forth in this section is contrary to or otherwise inconsistent with a definition set forth in a patent, application, or other publication that is herein incorporated by reference, the definition set forth in this section prevails over the definition incorporated herein by reference.

The singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. The terms “including,” “containing,” and “comprising” are used in their open, non-limiting sense.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. In some embodiments, the term “about” in reference to a number or range of numbers is understood to mean the stated number and numbers +/−10% thereof, or 10% below the lower listed limit and 10% above the higher listed limit for the values listed for a range.

Certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination. All combinations of the embodiments pertaining to the chemical groups represented by the variables are specifically embraced by the present disclosure and are disclosed herein just as if each and every combination was individually and explicitly disclosed, to the extent that such combinations embrace compounds that are stable compounds (i.e., compounds that can be isolated, characterized, and tested for activity). In addition, all subcombinations of the chemical groups listed in the embodiments describing such variables are also specifically embraced by the present disclosure and are disclosed herein just as if each and every such sub-combination of chemical groups was individually and explicitly disclosed herein.

In one aspect, a composition for hydraulic fracturing includes a dry friction reducing polymer and a surfactant.

In embodiments, the friction reducing polymer may be based on a polyacrylamide. A polyacrylamide has a repeating unit of —(—CH₂CHC(O)NH₂—)—. An alternative representation of a repeating unit of polyacrylamide is:

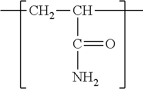

In embodiments, the surfactant is a substance capable of adsorbing to solid surfaces and/or fluid interfaces and affect the surface tension or interfacial tension between two substances. Surfactants are also known as “surface active agents” in the literature. In embodiments, the surfactant is selected from the group consisting of dodecyl benzene sulphonic acid, cocamidopropyl betaine, sodium cocoiminodipropionate, dodecyl benzene sulphonic acid, dodecylbenzene dulphonate sodium salt, sodium lauryl sulphate, alkyl ether sulfate sodium salt, cetyl oleyl ethoxy phosphate, phenol+4EO phosphate ester-acid form. C8-10 alkyl polyglucosides, C10 alcohol+8EO, C13 alcohol+7EO, C16-18 alcohol+35EO, ethoxylated propoxylated C8-18 alcohols, oleic acid+10EO, PEG400 mono-oleate, sorbitan monostearate, sorbitan trioleate, tallow amine+15EO, lauryl amine oxide, and a combination of two or more thereof.

In embodiments, the composition comprises a plurality of particles having an average particle size from 15 μm to 45 μm. That is, the average particle size may be from 20 μm to 40 μm, from 25 μm to 35 μm, or even about 30 μm. Methods to determine average particle size are known. For instance, average particle size could be determined by laser scattering particle size distribution analysis (laser diffraction).

In embodiments, the composition may include substances in addition to the dry friction reducing polymer and surfactant. For instance, the composition may include a wetting agent. Wetting agents are substances that increase the spreading and penetrating properties of a liquid by lowering its surface tension. In embodiments, the wetting agent may be selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated)methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

In another aspect, a method for producing a dry friction reducing composition for hydraulic fracturing comprises mixing a dry friction reducing polymer comprising polyacrylamide with a surfactant to produce a course composition; and processing the course composition to form the dry friction reducing composition, as described above.

Mixing the dry friction reducing polymer with the surfactant may be accomplished by techniques known in the art. For instance, a solution containing the surfactant could be applied to dry particles of the friction reducing polymer. In other embodiments, the dry friction reducing polymer may be spray coated with the surfactant or a solution containing the surfactant.

Processing the course composition may be accomplished by techniques known in the art. For instance, the course composition may be processed by milling, grinding, or crushing until the desired particle size of from 15 μm to 45 μm is reached. Exemplary instrumentation to effect a reduction in particle size include, but are not limited to, roller mills, hammer mills, pulverizers, microfluidizers, and step grinders.

In another aspect, a geologic formation may include a composition for hydraulic fracturing. Such a composition may include the dry friction reducing polymer and a surfactant, as described above.

In another aspect, a method for extracting crude oil and natural gas from a geologic formation may include supplying the composition for hydraulic fracturing, as described above, to the geologic formation. In some embodiments, supplying the composition may include adding the composition to a mobile delivery apparatus at a first site that is not the geologic formation; and delivering the mobile delivery apparatus to a second site housing the geologic formation. In some embodiments, supplying the composition may include dosing the composition directly into the geologic formation.

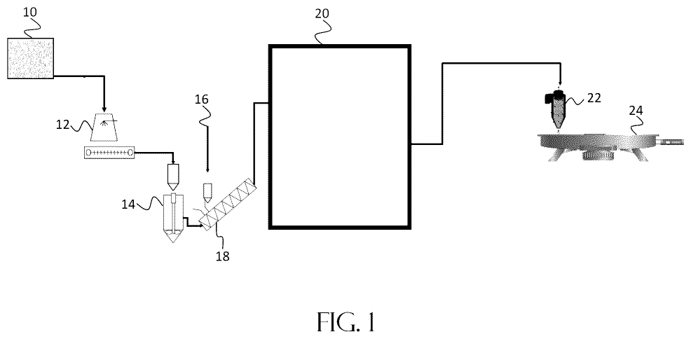

FIG. 1 provides a schematic of an exemplary system for delivering the composition for hydraulic fracturing to a geologic formation. Dry friction reducing polymer 10 is added to coating apparatus 12 along with the surfactant and, if applicable, wetting agents. The thus coated course composition is next added to pulverizer 14. After reducing the particle size of the coarse material, thereby forming the dry friction reducing composition, the dry friction reducing composition and optionally other additives pass through screw conveyor 18 into dosing system 20. Dosing system 20 may be a mobile container vessel that may be moved from a manufacturing plant to the drill site. At the drill site, the dry friction reducing composition is moved from the dosing system 20 into an air/solids separator 22, which directly injects the dry friction reducing composition into blender tub 24 to be mixed with fracking fluid for hydraulic fracturing.

Aspects of the present disclosure can be described as embodiments in any of the following enumerated clauses. It will be understood that any of the described embodiments can be used in connection with any other described embodiments to the extent that the embodiments do not contradict one another.

1. A composition for hydraulic fracturing, the composition comprising:
a dry friction reducing polymer comprising polyacrylamide; and
a surfactant,
wherein the composition comprises a plurality of particles having an average particle size of from 15 μm to 45 μm.

2. The composition of clause 1, wherein the surfactant is selected from the group consisting of dodecyl benzene sulphonic acid, cocamidopropyl betaine, sodium cocoiminodipropionate, dodecyl benzene sulphonic acid, dodecylbenzene dulphonate sodium salt. sodium lauryl sulphate, alkyl ether sulfate sodium salt, cetyl oleyl ethoxy phosphate, phenol+4EO phosphate ester-acid form, C8-10 alkyl polyglucosides, C10 alcohol+8EO, C13 alcohol+7EO, C16-18 alcohol+35EO, ethoxylated propoxylated C8-18 alcohols, oleic acid+10EO, PEG400 mono-oleate, sorbitan monostearate, sorbitan triolcate, tallow amine+15EO, lauryl amine oxide, and a combination of two or more thereof.

3. The composition of clause 1, further comprising a wetting agent selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated) methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

4. The composition of clause 1, wherein the plurality of particles have an average particle size from 25 μm to 35 μm.

5. The composition of clause 1, wherein the plurality of particles have an average particle size of about 30 μm.

6. A method for producing a dry friction reducing composition for hydraulic fracturing, the method comprising:
mixing a dry friction reducing polymer comprising polyacrylamide with a surfactant to produce a course composition; and
processing the course composition to form the dry friction reducing composition, the dry friction reducing composition comprising a plurality of particles having an average particle size of from 15 μm to 45 μm.

7. The method of clause 6, wherein the surfactant is selected from the group consisting dodecyl benzene sulphonic acid, cocamidopropyl betaine, sodium cocoiminodipropionate, dodecyl benzene sulphonic acid, dodecylbenzene dulphonate sodium salt, sodium lauryl sulphate, alkyl ether sulfate sodium salt, cetyl oleyl ethoxy phosphate, phenol+4EO phosphate ester-acid form, C8-10 alkyl polyglucosides, C10 alcohol+8EO, C13 alcohol+7EO, C16-18 alcohol+35EO, ethoxylated propoxylated C8-18 alcohols, oleic acid+10EO. PEG400 mono-oleate, sorbitan monostearate, sorbitan trioleate, tallow amine+15EO, lauryl amine oxide. and a combination of two or more thereof.

8. The method of clause 6, wherein the course composition further comprises a wetting agent selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated)methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

9. The method of clause 6, wherein the plurality of particles have an average particle size from 25 μm to 35 μm.

10. The method of clause 6, wherein the plurality of particles have an average particle size of about 30 μm.

11. A geologic formation comprising a composition for hydraulic fracturing, the composition comprising:
a dry friction reducing polymer comprising polyacrylamide; and a surfactant,
wherein the composition comprises a plurality of particles having an average particle size of from 15 μm to 45 μm.

12. The geologic formation of clause 11, wherein the surfactant is selected from the group consisting of dodecyl benzene sulphonic acid, cocamidopropyl betaine, sodium cocoiminodipropionate, dodecyl benzene sulphonic acid, dodecylbenzene dulphonate sodium salt. sodium lauryl sulphate, alkyl ether sulfate sodium salt, cetyl oleyl ethoxy phosphate, phenol+4EO phosphate ester-acid form, C8-10 alkyl polyglucosides, C10 alcohol+8EO, C13 alcohol+7EO, C16-18 alcohol+35EO, ethoxylated propoxylated C8-18 alcohols, oleic acid+10EO, PEG400 mono-oleate, sorbitan monostearate, sorbitan triolcate, tallow amine+15EO, lauryl amine oxide. and a combination of two or more thereof.

13. The geologic formation of clause 11, further comprising a wetting agent selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated)methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

14. The geologic formation of clause 11, wherein the plurality of particles have an average particle size from 25 μm to 35 μm.

15. The geologic formation of clause 11, wherein the plurality of particles have an average particle size of about 30 μm.

16. A method for extracting crude oil and natural gas from a geologic formation, the method comprising:
supplying a composition for hydraulic fracturing to the geologic formation comprising:
a dry friction reducing polymer comprising polyacrylamide; and a surfactant,
wherein the composition comprises a plurality of particles having an average particle size of from 15 μm to 45 μm.

17. The method of clause 16, wherein the surfactant is selected from the group consisting of dodecyl benzene sulphonic acid, cocamidopropyl betaine, sodium cocoiminodipropionate, dodecyl benzene sulphonic acid, dodecylbenzene dulphonate sodium salt, sodium lauryl sulphate. alkyl ether sulfate sodium salt, cetyl oleyl ethoxy phosphate, phenol+4EO phosphate ester-acid form, C8-10 alkyl polyglucosides, C10 alcohol+8EO, C13 alcohol+7EO, C16-18 alcohol+35EO, ethoxylated propoxylated C8-18 alcohols, oleic acid+10EO. PEG400 mono-oleate, sorbitan monostearate, sorbitan trioleate, tallow amine+15EO, lauryl amine oxide. and a combination of two or more thereof.

18. The method of clause 16, wherein the course composition further comprises a wetting agent selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated)methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

19. The method of clause 16, wherein the plurality of particles have an average particle size from 25 μm to 35 μm.

20. The method of clause 16, wherein the plurality of particles have an average particle size of about 30 μm.

21. The method of clause 16, wherein the supplying the composition for hydraulic fracturing to the geologic formation comprises:
adding the composition to a mobile delivery apparatus at a first site that is not the geologic formation; and
delivering the mobile delivery apparatus to a second site housing the geologic formation.

22. The method of clause 21, wherein the supplying the composition for hydraulic fracturing to the geologic formation comprises:
dosing the composition from the mobile delivery apparatus into a secondary container comprising hydraulic fracturing fluid precursor to produce a hydraulic fracturing fluid; and
supplying the hydraulic fracturing fluid to the geologic formation.

23. The method of clause 21, wherein the supplying the composition for hydraulic fracturing to the geologic formation comprises:
dosing the composition directly into the geologic formation.

While embodiments of the present disclosure have been described herein, it is to be understood by those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A composition for hydraulic fracturing, the composition comprising:
a dry friction reducing polymer comprising polyacrylamide; and
a surfactant,
wherein the composition comprises a plurality of particles having an average particle size of from 15 μm to 45 μm.

2. The composition of claim 1, wherein the surfactant is selected from the group consisting of dodecyl benzene sulphonic acid, cocamidopropyl betaine, sodium cocoiminodipropionate, dodecyl benzene sulphonic acid, dodecylbenzene dulphonate sodium salt, sodium lauryl sulphate, alkyl ether sulfate sodium salt, cetyl oleyl ethoxy phosphate, phenol+4EO phosphate ester-acid form, C8-10 alkyl polyglucosides, C10 alcohol+8EO, C13 alcohol+7EO, C16-18 alcohol+35EO, ethoxylated propoxylated C8-18 alcohols, oleic acid+10EO, PEG400 mono-oleate, sorbitan monostearate, sorbitan trioleate, tallow amine+15EO, lauryl amine oxide, and a combination of two or more thereof.

3. The composition of claim 1, further comprising a wetting agent selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated)methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

4. The composition of claim 1, wherein the plurality of particles have an average particle size from 25 μm to 35 μm.

5. The composition of claim 1, wherein the plurality of particles have an average particle size of about 30 μm.

6. A method for producing dry friction reducing composition for hydraulic fracturing, the method comprising:
mixing a dry friction reducing polymer comprising polyacrylamide with a surfactant to produce a course composition; and
processing the course composition to form the dry friction reducing composition, the dry friction reducing composition comprising a plurality of particles having an average particle size of from 15 μm to 45 μm.

7. The method of claim 6, wherein the surfactant is selected from the group consisting of dodecyl benzene sulphonic acid, cocamidopropyl betaine, sodium cocoiminodipropionate, dodecyl benzene sulphonic acid, dodecylbenzene dulphonate sodium salt, sodium lauryl sulphate, alkyl ether sulfate sodium salt, cetyl oleyl ethoxy phosphate, phenol+4EO phosphate ester-acid form, C8-10 alkyl polyglucosides, C10 alcohol+8EO, C13 alcohol+7EO, C16-18 alcohol+35EO, ethoxylated propoxylated C8-18 alcohols, oleic acid+10EO, PEG400 mono-oleate, sorbitan monostearate, sorbitan trioleate, tallow amine+15EO, lauryl amine oxide, and a combination of two or more thereof.

8. The method of claim 6, wherein the course composition further comprises a wetting agent selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated)methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

9. The method of claim 6, wherein the plurality of particles have an average particle size from 25 μm to 35 μm.

10. The method of claim 6, wherein the plurality of particles have an average particle size of about 30 μm.

11. A geologic formation comprising a composition for hydraulic fracturing, the composition comprising:
a dry friction reducing polymer comprising polyacrylamide; and
a surfactant,
wherein the composition comprises a plurality of particles having an average particle size of from 15 μm to 45 μm.

12. The geologic formation of claim 11, wherein the surfactant is selected from the group consisting of dodecyl benzene sulphonic acid, cocamidopropyl betaine, sodium cocoiminodipropionate, dodecyl benzene sulphonic acid, dodecylbenzene dulphonate sodium salt, sodium lauryl sulphate, alkyl ether sulfate sodium salt, cetyl oleyl ethoxy phosphate, phenol+4EO phosphate ester-acid form, C8-10 alkyl polyglucosides, C10 alcohol+8EO, C13 alcohol+7EO, C16-18 alcohol+35EO, ethoxylated propoxylated C8-18 alcohols, oleic acid+10EO, PEG400 mono-oleate, sorbitan monostearate, sorbitan trioleate, tallow amine+15EO, lauryl amine oxide, and a combination of two or more thereof.

13. The geologic formation of claim 11, further comprising a wetting agent selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated)methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

14. The geologic formation of claim 11, wherein the plurality of particles have an average particle size from 25 μm to 35 μm.

15. The geologic formation of claim 11, wherein the plurality of particles have an average particle size of about 30 μm.

16. A method for extracting crude oil and natural gas from a geologic formation, the method comprising:
supplying a composition for hydraulic fracturing to the geologic formation comprising:
a dry friction reducing polymer comprising polyacrylamide; and
a surfactant,
wherein the composition comprises a plurality of particles having an average particle size of from 15 μm to 45 μm.

17. The method of claim 16, wherein the surfactant is selected from the group consisting of dodecyl benzene sulphonic acid, cocamidopropyl betaine, sodium cocoiminodipropionate, dodecyl benzene sulphonic acid, dodecylbenzene dulphonate sodium salt, sodium lauryl sulphate, alkyl ether sulfate sodium salt, cetyl oleyl ethoxy phosphate, phenol+4EO phosphate ester-acid form, C8-10 alkyl polyglucosides, C10 alcohol+8EO, C13 alcohol+7EO, C16-18 alcohol+35EO, ethoxylated propoxylated C8-18 alcohols, oleic acid+10EO, PEG400 mono-oleate, sorbitan monostearate, sorbitan trioleate, tallow amine+15EO, lauryl amine oxide, and a combination of two or more thereof.

18. The method of claim 16, wherein the course composition further comprises a wetting agent selected from the group consisting of ethoxylated undecan-1-ol, ethoxylated 2,4,7,9-tetramethyl-5-decyn-4,7-diol, ethane-1,2-diol, branched and linear α-undecyl-ω-hydroxy-poly(oxy-1,2-ethanediyl), (coconut oil alkyl)bis(2-hydroxyethyl, ethoxylated)methylammonium chloride, propane-1,2-diol, glycerol, ethoxylated acetylenic diols, ethoxylated undecan-1-ol, branched α,α′-[[[3-(decyloxy)propyl]methyliminio]di-2,1-ethanediyl]bis[ω-hydroxy]-poly(oxy-1,2-ethanediyl)chloride, and a combination of two or more thereof.

19. The method of claim 16, wherein the plurality of particles have an average particle size from 25 μm to 35 μm.

20. The method of claim 16, wherein the plurality of particles have an average particle size of about 30 μm.

21. The method of claim 16, wherein the supplying the composition for hydraulic fracturing to the geologic formation comprises:
adding the composition to a mobile delivery apparatus at a first site that is not the geologic formation; and
delivering the mobile delivery apparatus to a second site housing the geologic formation.

22. The method of claim 21, wherein the supplying the composition for hydraulic fracturing to the geologic formation comprises:
dosing the composition from the mobile delivery apparatus into a secondary container comprising hydraulic fracturing fluid precursor to produce a hydraulic fracturing fluid; and
supplying the hydraulic fracturing fluid to the geologic formation.

23. The method of claim 21, wherein the supplying the composition for hydraulic fracturing to the geologic formation comprises:
dosing the composition directly into the geologic formation.
